(19) United States
(12) Patent Application Publication
(10) Pub. No.: US 2024/0353068 A1
(43) Pub. Date: Oct. 24, 2024

(54) INTEGRALLY-TRANSPORTABLE PURGE CONTAINER AND METHOD OF USING THE INTEGRALLY-TRANSPORTABLE PURGE CONTAINER

(71) Applicant: EBARA CORPORATION, Tokyo (JP)

(72) Inventors: Shuichiro HONDA, Tokyo (JP); Tetsuji KASATANI, Tokyo (JP); Hayato IKEDA, Tokyo (JP); Mitsutaka IWAMI, Tokyo (JP)

(21) Appl. No.: 18/683,004

(22) PCT Filed: Aug. 9, 2022
(86) PCT No.: PCT/JP2022/030377

§ 371 Date: Feb. 12, 2024

(30) Foreign Application Priority Data
Aug. 17, 2021 (JP) 2021-132899

(51) Int. Cl. F17C 9/00

(52) U.S. Cl. CPC F17C 9/00; F17C 2201/0104; F17C 2201/032; F17C 2201/052; F17C 2205/0323; F17C 2221/012; F17C 2223/0153; F17C 2223/046; F17C 2227/0142; F17C 2227/0178; F17C 2227/044; F17C 2250/0439; F17C 2250/0491

(57) ABSTRACT

An integrally-transportable purge container capable of preventing entry of air when a submersible pump is carried into a pump column, and capable of warming the submersible pump when it is removed from the pump column to prevent components of the air from being liquefied is provided. The integrally-transportable purge container includes: a container body having an interior space for accommodating a submersible pump therein; an upper lid configured to cover an upper opening of the container body; a lower lid configured to cover a lower opening of the container body; and a purge-gas inlet port and a purge-gas outlet port communicating with the interior space of the container body. The integrally-transportable purge container is detachably coupled to an upper portion of a pump column in which the submersible pump is to be installed. The integrally-transportable purge container is configured to be transportable together with the submersible pump.

### TECHNICAL FIELD

The present invention relates to an integrally-transportable purge container for exposing a submersible pump for pressurizing liquefied gas, such as liquefied ammonia, liquefied natural gas (LNG), or liquid hydrogen, to purge gas. Further, the present invention relates to a method of exposing the submersible pump to the purge gas using such an integrally-transportable purge container.

### BACKGROUND ART

Natural gas is widely used for thermal power generation and used as a raw material for chemicals. Furthermore, ammonia and hydrogen are expected to be energies that do not generate carbon dioxide that causes global warming. Applications of hydrogen as an energy include fuel cell and turbine power generation. Natural gas, ammonia, and hydrogen are in a gaseous state at normal temperature, and therefore natural gas, ammonia, and hydrogen are cooled and liquefied for their storage and transportation. Liquefied gas, such as liquefied natural gas (LNG), liquefied ammonia, and liquefied hydrogen, is temporarily stored in a liquefied-gas storage tank and then delivered to a power plant, factory, or the like by a pump.

FIG. 17 is a schematic diagram showing a conventional example of a liquefied-gas storage tank in which liquefied gas is stored and a pump for pumping up the liquefied gas. A pump 500 is installed in a vertical pump column 505 disposed in a liquefied-gas storage tank 501. The inside of the pump column 505 is filled with the liquefied gas, and the entire pump 500 is immersed in the liquefied gas. The pump 500 is thus a submersible pump that can operate in the liquefied gas. When the pump 500 is operated, the liquefied gas in the liquefied-gas storage tank 501 is sucked into the pump column 505, ascends in the pump column 505, and is discharged from the pump column 505 through a liquefied-gas discharge port 509.

### CITATION LIST

### Patent Literature

Patent document 1: Japanese Patent No. 3197645

Patent document 2: Japanese Patent No. 3198248

Patent document 3: Japanese Patent No. 3472379

### SUMMARY OF INVENTION

### Technical Problem

The pump 500 is a machine that contains consumables, and therefore the pump 500 requires regular maintenance. When the pump 500 is installed in the pump column 505 for the first time and when the pump 500 is returned to the pump column 505 after the maintenance, it is necessary to prevent air, entrained by the pump 500, from entering the pump column 505. If air enters the pump column 505 together with the pump 500, moisture in the air will be cooled and solidified by the ultra-low temperature liquefied gas, and as a result, the rotation of the pump 500 will be hindered. In particular, when the liquefied gas is liquid hydrogen, nitrogen and oxygen in the air are liquefied or solidified and may be mixed into the liquefied gas. The solidification of nitrogen and oxygen can damage equipment. Moreover, mixture of the liquefied oxygen and the liquid hydrogen can cause an explosion.

When the pump 500 is removed from the pump column 505 for the purpose of maintenance, etc., it is also necessary to prevent ambient air from entering the pump column 505. Specifically, the pump 500 that has been in contact with the liquefied gas has an extremely low temperature, and when the air contacts such low-temperature pump 500, the moisture contained in the air is liquefied or solidified on the surface of the pump 500, and may fall into the pump column 505 and may be mixed with the liquefied gas. Especially when the liquefied gas is liquid hydrogen, the following problem may occur. The temperature of liquid hydrogen is −253° C. or less, and therefore the pump 500 just removed from the pump column 505 also has an ultra-low temperature equivalent to that of the liquid hydrogen. When the air comes into contact with such ultra-low temperature pump 500, not only the nitrogen in the air but also the oxygen is liquefied. If the liquefied oxygen drops into the liquefied-gas storage tank 501 and mixes with the liquid hydrogen, an explosion may occur, which is extremely dangerous.

Therefore, the present invention provides an integrally-transportable purge container and a method of using the same capable of preventing entry of air when a submersible pump is carried into a pump column, and capable of warming the submersible pump when it is removed from the pump column to prevent components of the air from being liquefied.

### Solution to Problem

In an embodiment, there is provided an integrally-transportable purge container for exposing a submersible pump to purge gas, the submersible pump being used to deliver liquefied gas, the integrally-transportable purge container comprising: a container body having an interior space for accommodating the submersible pump therein; an upper lid configured to cover an upper opening of the container body; a lower lid configured to cover a lower opening of the container body; and a purge-gas inlet port and a purge-gas outlet port communicating with the interior space of the container body, the integrally-transportable purge container being configured to be detachably coupled to an upper portion of a pump column in which the submersible pump is to be installed, and the integrally-transportable purge container being configured to be transportable together with the submersible pump.

In an embodiment, the integrally-transportable purge container further comprises a pump guide fixed to an inner surface of the container body, the pump guide being configured to suppress lateral shaking of the submersible pump.

In an embodiment, the integrally-transportable purge container further comprises a fixing device configured to removably fix the upper lid to the container body.

In an embodiment, the integrally-transportable purge container further comprises a side lid configured to close an opening formed in a side wall of the container body.

In an embodiment, the integrally-transportable purge container further comprises: an inlet valve coupled to the purge-gas inlet port; and an outlet valve coupled to the purge-gas outlet port.

In an embodiment, the integrally-transportable purge container further comprises a pump suspension mechanism removably attached to the upper lid, the pump suspension mechanism being configured to suspend the submersible pump within the interior space.

In an embodiment, the pump suspension mechanism includes a coupling member coupled to the submersible pump, and a stopper engaged with the coupling member, and the upper lid has a hole having a shape that does not allow the stopper to pass through the hole.

In an embodiment, the lower lid is configured to support the submersible pump.

In an embodiment, the lower lid is removably attached to the container body.

In an embodiment, the lower lid is composed of a gate valve, and the purge container further comprises a gate-valve opening-closing device configured to open and close the gate valve.

In an embodiment, there is provided an integrally-transportable purge container for exposing a submersible pump to purge gas, the submersible pump being used to deliver liquefied gas, the integrally-transportable purge container comprising: a container body having an interior space for accommodating the submersible pump therein; an upper lid configured to cover an upper opening of the container body; a lower lid configured to cover a lower opening of the container body; a purge-gas inlet port and a purge-gas outlet port communicating with the interior space of the container body; and a sealing member configured to seal a gap between the container body and the lower lid when the lower lid covers the lower opening of the container body, wherein the lower opening of the container body has a size that allows the submersible pump to pass through the lower opening when the lower lid is removed, and the integrally-transportable purge container is transportable together with the submersible pump disposed in the container body to an upper portion of a pump column and away from the upper portion of the pump column.

In an embodiment, there is provided an integrally-transportable purge container for exposing a submersible pump to purge gas, the submersible pump being used to deliver liquefied gas, the integrally-transportable purge container comprising: a container body having an interior space for accommodating the submersible pump therein; an upper lid configured to cover an upper opening of the container body; a lower lid configured to cover a lower opening of the container body; a purge-gas inlet port and a purge-gas outlet port communicating with the interior space of the container body; and a pump guide configured to suppress lateral shaking of the submersible pump when the submersible pump is in the container body, wherein a predetermined clearance is maintained between the pump guide and the submersible pump, and the integrally-transportable purge container is transportable together with the submersible pump disposed in the container body to an upper portion of a pump column and away from the upper portion of the pump column.

In an embodiment, there is provided a method of using an integrally-transportable purge container for exposing a submersible pump to a purge gas, the submersible pump being used to deliver liquefied gas, the method comprising: disposing the submersible pump in an interior space of a container body of the integrally-transportable purge container; transporting the integrally-transportable purge container together with the submersible pump disposed therein to a pump column; coupling the integrally-transportable purge container to an upper portion of the pump column; and filling the interior space accommodating the submersible pump with purge gas before or after transporting the integrally-transportable purge container to the pump column.

In an embodiment, the liquefied gas comprises liquid hydrogen, and at least a part of the purge gas comprises a gas composed of a component having a boiling point equal to or lower than a boiling point of hydrogen.

In an embodiment, the purge gas comprises hydrogen gas.

In an embodiment, the method further comprises expelling the liquefied gas from the pump column before or after transporting the integrally-transportable purge container to the pump column.

In an embodiment, the method further comprises lowering the submersible pump from the integrally-transportable purge container into the pump column by an elevating device.

In an embodiment, the method further comprises separating the integrally-transportable purge container from the pump column after lowering the submersible pump into the pump column.

In an embodiment, the method further comprises: coupling the integrally-transportable purge container to the upper portion of the pump column again; and elevating the submersible pump from the pump column into the integrally-transportable purge container by the elevating device while supplying purge gas into the interior space of the integrally-transportable purge container.

In an embodiment, the method further comprises filling the interior space accommodating the submersible pump with purge gas after the submersible pump is elevated into the integrally-transportable purge container.

In an embodiment, the method further comprises: separating the integrally-transportable purge container accommodating the submersible pump from the pump column again; and transporting the integrally-transportable purge container and the submersible pump together.

### Advantageous Effects of Invention

According to the present invention, air and moisture entrained with the submersible pump are removed from the submersible pump by the purge gas, and as a result, the submersible pump is dried or deaerated (this operation will be hereinafter referred to as drying-up operation). After this drying-up operation, the submersible pump can be quickly moved into the pump column with the purge gas present around the submersible pump. Therefore, the air and moisture are not entrained with the submersible pump, and the air and moisture are prevented from entering the pump column.

Furthermore, according to the present invention, the ultra-low temperature submersible pump can be warmed with the purge gas while being elevated from the pump column into the integrally-transportable purge container (this operation will be hereinafter This hot-up operation is performed before the referred to as hot-up operation). submersible pump contacts the atmospheric air, so that moisture in the air is not liquefied or solidified on the surfaces of the submersible pump. In particular, the present invention is effective when the liquefied gas is liquid hydrogen. Specifically, the submersible pump that has been immersed in liquid hydrogen has an ultra-low temperature equivalent to that of liquid hydrogen when the submersible pump is pulled out of the pump column. The boiling point of hydrogen (−253° C.) is lower than the boiling point of oxygen (−183° C.) and the boiling point of nitrogen (−196° C.). Therefore, when the air comes into contact with the submersible pump immediately after the submersible pump is pulled out of the pump column, not only nitrogen in the air, but also oxygen is liquefied and drops into the pump column. In this respect, according to the present invention, the submersible pump that has been immersed in the liquid hydrogen is rapidly warmed by the purge gas before the submersible pump contacts the air. Therefore, when the air contacts the submersible pump, the oxygen and the nitrogen in the air are not liquefied, and the liquefied oxygen and liquefied nitrogen do not fall into the pump column. As a result, safe removal of the submersible pump can be achieved.

### BRIEF DESCRIPTION OF DRAWINGS

FIG. 1 is a schematic diagram for explaining an operation of exposing a submersible pump to purge gas within an integrally-transportable purge container before the submersible pump is installed in a pump column;

FIG. 2 is a cross-sectional view of an embodiment of the integrally-transportable purge container;

FIG. 3 is a schematic diagram showing the integrally-transportable purge container coupled to an upper portion of the pump column;

FIG. 4 illustrates an embodiment of a method of exposing the submersible pump to purge gas using the integrally-transportable purge container;

FIG. 5 illustrates an embodiment of the method of exposing the submersible pump to the purge gas using the integrally-transportable purge container;

FIG. 6 illustrates an embodiment of a process of pulling up the submersible pump out of the pump column;

FIG. 7 illustrates an embodiment of the process of pulling up the submersible pump out of the pump column;

FIG. 8 is a cross-sectional view showing another embodiment of the integrally-transportable purge container;

FIG. 9 is a schematic diagram showing the integrally-transportable purge container coupled to an upper portion of the pump column;

FIG. 10 illustrates an embodiment of a method of exposing the submersible pump to the purge gas using the integrally-transportable purge container shown in FIG. 8;

FIG. 11 illustrates an embodiment of the method of exposing the submersible pump to the purge gas using the integrally-transportable purge container shown in FIG. 8;

FIG. 12 illustrates an embodiment of a process of pulling up the submersible pump out of the pump column;

FIG. 13 illustrates one embodiment of the process of pulling up the submersible pump out of the pump column;

FIG. 14 is a cross-sectional view showing still another embodiment of the integrally-transportable purge container;

FIG. 15 is a schematic diagram showing the integrally-transportable purge container coupled to an upper portion of the pump column;

FIG. 16 is a schematic diagram showing the integrally-transportable purge container when a gate valve is open; and

FIG. 17 is a schematic diagram showing a conventional example of a liquefied-gas storage tank in which liquefied gas is stored and a pump for pumping up the liquefied gas.

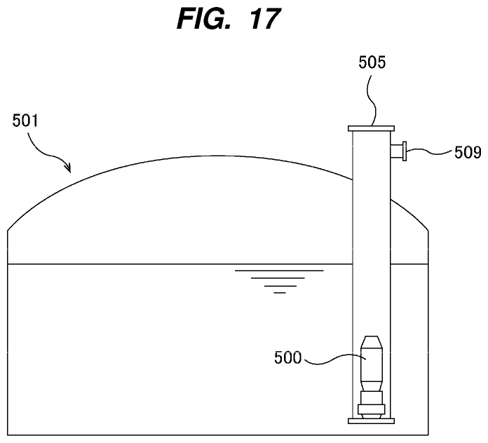

### DESCRIPTION OF EMBODIMENTS

Hereinafter, embodiments of the present invention will be described with reference to the drawings.

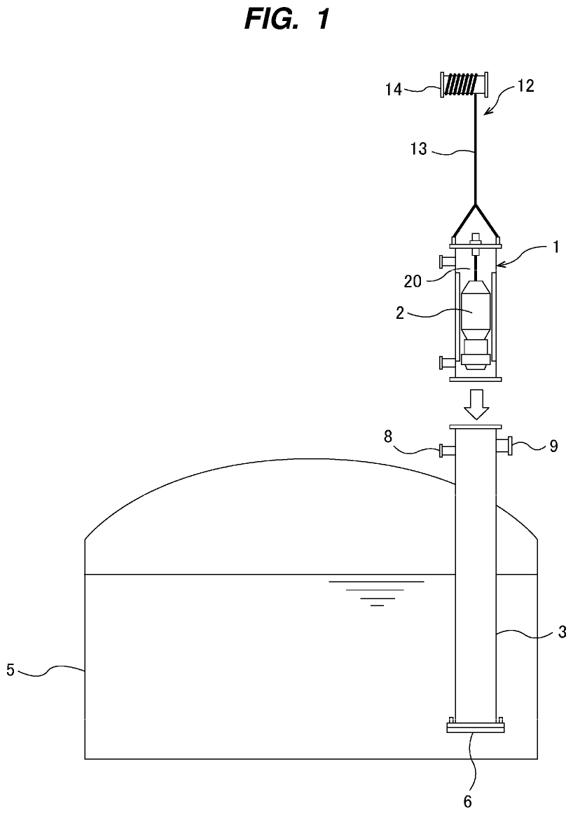

FIG. 1 is a schematic diagram for explaining an operation of exposing a submersible pump to purge gas in an integrally-transportable purge container before the submersible pump is installed in a pump column. An integrally-transportable purge container 1 is a device for exposing a submersible pump 2 to purge gas. The submersible pump 2 is used for delivering liquefied gas. Examples of the liquefied gas include liquefied ammonia, liquid hydrogen, liquid nitrogen, liquefied natural gas, liquefied ethylene gas, liquefied petroleum gas, etc. The integrally-transportable purge container 1 is detachably coupled to a pump column 3. The integrally-transportable purge container 1 is configured to be able to be transported together with the submersible pump 2 accommodated therein. This makes it possible to insert the submersible pump 2 into the integrally-transportable purge container 1 in a stable location, thus contributing to safety and efficiency of work. Moreover, the use of the integrally-transportable purge container 1 contributes to preventing an accident that may occur when the submersible pump 2 is transported into the pump column 3 installed in a liquefied-gas storage tank 5.

As shown in FIG. 1, the pump column 3 is installed in the liquefied-gas storage tank 5 in which the liquefied gas is stored. The pump column 3 is a vertically extending hollow container, and its upper part protrudes upward from the liquefied-gas storage tank 5. A suction valve 6 is provided at a bottom of the pump column 3. The submersible pump 2 is installed on the bottom of the pump column 3. The structure of the suction valve 6 is not particularly limited. For example, the suction valve 6 may be of a type in which the suction valve 6 is opened by the weight of the submersible pump 2, or may be an actuator-driven valve (for example, an electric valve).

The integrally-transportable purge container 1 is transported to a position above the pump column 3 together with the submersible pump 2 by a transporting device (not shown), such as a crane. Further, as shown in FIG. 1, the integrally-transportable purge container 1 is coupled to a cable 13 of an elevating device 12. The integrally-transportable purge container 1 is elevated and lowered together with the submersible pump 2 by the elevating device 12. The elevating device 12 has a take-up device 14, such as a hoist or a winch, for hoisting the cable 13.

An interior space 20 of the integrally-transportable purge container 1 is filled with purge gas, and the submersible pump 2 is exposed to the purge gas (i.e., the submersible pump 2 contacts the purge gas). The integrally-transportable purge container 1 is configured to be coupled to the upper portion of the pump column 3. The interior space 20 of the integrally-transportable purge container 1 is filled with the purge gas before the integrally-transportable purge container 1 is coupled to the upper portion of the pump column 3. Specifically, the purge gas is supplied into the integrally-transportable purge container 1 when the submersible pump 2 is located in the integrally-transportable purge container 1. With the interior space 20 of the integrally-transportable purge container 1 filled with the purge gas, the integrally-transportable purge container 1 is elevated or lowered together with the submersible pump 2 by the elevating device 12.

The purge gas may be supplied into the integrally-transportable purge container 1 at a location remote from the liquefied-gas storage tank 5. Alternatively, the purge gas may be supplied into the integrally-transportable purge container 1 after the integrally-transportable purge container 1 is coupled to the cable 13 of the elevating device 12 and before the integrally-transportable purge container 1 is coupled to the upper portion of the pump column 3. In one embodiment, the purge gas may be supplied into the integrally-transportable purge container 1 after the integrally-transportable purge container 1 is coupled to the upper portion of the pump column 3 and before the submersible pump 2 is moved into the pump column 3 by the elevating device 12. In either case, the submersible pump 2 is exposed to the purge gas within the integrally-transportable purge container 1, so that air and moisture are expelled from an interior and surfaces of the submersible pump 2. In the following descriptions, the process of exposing the submersible pump 2 to the purge gas in the integrally-transportable purge container 1 before the submersible pump 2 is put into the pump column 3 is called drying-up operation.

The liquefied gas is discharged from the pump column 3 before or after the drying-up operation. Specifically, with an upper opening of the pump column 3 closed, purge gas is supplied into the pump column 3 through a purge-gas introduction port 8, so that the liquefied gas is discharged from the pump column 3 through the suction valve 6 by the pressure of the purge gas. In one embodiment, discharging of the liquefied gas from the pump column 3 may be performed before the integrally-transportable purge container 1 is transported together with the submersible pump 2 to the position above the pump column 3. In one embodiment, discharging of the liquefied gas from the pump column 3 may be performed after the integrally-transportable purge container 1 has been transported together with the submersible pump 2 to the position above the pump column 3.

After the submersible pump 2 is disposed at the upper portion of the pump column 3 and the drying-up operation for the submersible pump 2 is completed, the submersible pump 2 is lowered (moved) from the integrally-transportable purge container 1 into the pump column 3 by the elevating device 12 until the submersible pump 2 is installed on the bottom of the pump column 3. Before or after the submersible pump 2 is installed on the bottom of the pump column 3, the upper opening of the pump column 3 is closed by a lid. When the suction valve 6 is opened, the liquefied gas in the liquefied-gas storage tank 5 flows into the pump column 3. The submersible pump 2 is operated to pump up the liquefied gas while the entire submersible pump 2 is immersed in the liquefied gas. The submersible pump 2 is a pump configured to be operable in liquid. The purge-gas introduction port 8 and a liquefied-gas discharge port 9 are provided on the upper portion of the pump column 3. The liquefied gas pumped up by the submersible pump 2 is discharged through the liquefied-gas discharge port 9.

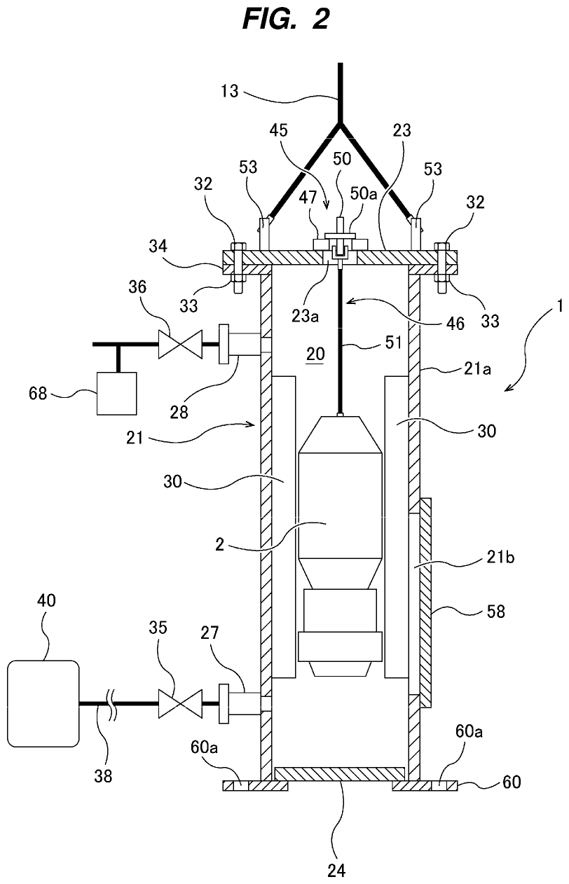

FIG. 2 is a cross-sectional view of one embodiment of the integrally-transportable purge container 1. The integrally-transportable purge container 1 includes a container body 21 having the interior space 20 for accommodating the submersible pump 2 therein, an upper lid 23 configured to cover an upper opening of the container body 21, a lower lid 24 configured to cover a lower opening of the container body 21, and a purge-gas inlet port 27 and a purge-gas outlet port 28 communicating with the interior space 20 of the container body 21. The container body 21 has a hollow structure. In this embodiment, the container body 21 has a cylindrical shape, but the shape of the container body 21 is not particularly limited. In one embodiment, the container body 21 may have a polygonal hollow structure, or may have other shape.

The integrally-transportable purge container 1 includes pump guides 30 configured to suppress lateral shaking of the submersible pump 2. The pump guides 30 are fixed to an inner surface of the container body 21. The pump guides 30 are arranged around the submersible pump 2 disposed in the container body 21. The pump guides 30 are provided for the purpose of suppressing (or preventing) the horizontal shaking of the submersible pump 2 within the container body 21 when the integrally-transportable purge container 1 with the submersible pump 2 disposed therein is transported by the transporting device, such as a crane. As long as such purpose can be achieved, multiple pump guides 30 may be provided, or a single pump guide 30 may be provided. For example, at least three pump guides 30 are arranged at regular intervals in the circumferential direction of the container body 21 and the submersible pump 2. In another example, a single pump guide 30 is arranged around the submersible pump 2.

The pump guide 30 may be made of metal, elastic material, or a combination thereof. In one embodiment, the pump guide(s) 30 may be fixed to the side surface of the submersible pump 2, instead of the inner surface of the container body 21.

It may be desirable that a predetermined clearance be provided between the submersible pump 2 and the pump guide 30, or between the submersible pump 2 having the pump guide 30 and the container body 21 so that they do not come into contact with each other. With this configuration, the submersible pump 2 can be inserted into the pump guide 30 or the submersible pump 2 with the pump guide 30 can be inserted into the container body 21. It may be desirable that axially upper and lower ends of the pump guide 30 are tapered. With this configuration, the submersible pump 2 or the submersible pump 2 having the pump guide 30 can be easily inserted into the pump guide 30 or into the container body 21. The pump guide 30 may desirably be provided on the side surface of the submersible pump 2, or the inner surface of the container body 21, or both of them so as not to interfere with the downward movement and the upward movement of the submersible pump 2.

Since the pump guide(s) 30 is provided in the integrally-transportable purge container 1, the submersible pump 2 contained in the integrally-transportable purge container 1 can be transported onto the upper portion of the pump column 3 or can be transported from the upper portion of the pump column 3. In particular, the submersible pump 2 and the integrally-transportable purge container 1 can be transported together.

The integrally-transportable purge container 1 includes a plurality of bolts 32 and a plurality of nuts 33 as fixing device for detachably fixing the upper lid 23 to the container body 21. The container body 21 has an upper flange 34 at the top of the container body 21. The plurality of bolts 32 extend through the upper lid 23 and the upper flange 34, and the plurality of nuts 33 are fastened to the plurality of bolts 32, respectively. When the nuts 33 are removed from the bolts 32, the upper lid 23 can be removed from the container body 21. In one embodiment, the fixing device that detachably fixes the upper lid 23 to the container body 21 may be one or more clamps, instead of the bolts 32 and the nuts 33.

The purge-gas inlet port 27 and the purge-gas outlet port 28 are fixed to a side wall 21a of the container body 21. More specifically, the purge-gas inlet port 27 is fixed to a lower part of the side wall 21a of the container body 21, and the purge-gas outlet port 28 is fixed to an upper part of the side wall 21a of the container body 21. In this embodiment, the purge-gas outlet port 28 is located higher than the purge-gas inlet port 27, while their arrangements are not limited to this embodiment. In one embodiment, the purge-gas inlet port 27 may be secured to the upper part of the side wall 21a of the container body 21, and the purge-gas outlet port 28 may be secured to the lower part of the side wall 21a of the container body 21. Alternatively, the purge-gas inlet port 27 and the purge-gas outlet port 28 may be located at the same height. Furthermore, in one embodiment, one of the purge-gas inlet port 27 and the purge-gas outlet port 28 may be fixed to the upper lid 23.

The integrally-transportable purge container 1 further includes an inlet valve 35 coupled to the purge-gas inlet port 27, and an outlet valve 36 coupled to the purge-gas outlet port 28. A purge-gas supply line 38 is detachably coupled to the inlet valve 35. This purge-gas supply line 38 is coupled to a purge-gas supply source 40. When the purge gas is to be supplied into the integrally-transportable purge container 1, the purge-gas supply line 38 is coupled to the inlet valve 35, and the inlet valve 35 is then opened. The purge gas is supplied from the purge-gas supply source 40 through the purge-gas supply line 38, the inlet valve 35, and the purge-gas inlet port 27 into the interior space 20 of the container body 21. While the purge gas is being supplied into the interior space 20, the outlet valve 36 is open and the air in the interior space 20 is replaced with the purge gas.

The purge gas used is gas composed of component (or element) having a boiling point lower than or equal to the boiling point of the liquefied gas to be pumped up by the submersible pump 2. This is because of preventing the purge gas from being liquefied when the purge gas contacts the liquefied gas or the ultra-low temperature submersible pump 2. Examples of purge gas include inert gas, such as nitrogen gas and helium gas. For example, when the liquefied gas to be pumped up by the submersible pump 2 is liquefied natural gas, nitrogen gas is used for the purge gas, since the nitrogen gas is composed of nitrogen having a boiling point (−196° C.) lower than the boiling point (−162° C.) of the liquefied natural gas. In another example, when the liquefied gas to be pumped up by the submersible pump 2 is liquid hydrogen, helium gas is used for the purge gas, since the helium gas is composed of helium having a boiling point (−269° C.) lower than the boiling point of hydrogen (−253° C.).

A part of the purge gas may contain a gas having the same component as that of the liquefied gas. If the purge-gas outlet port 28 is coupled to a gas treatment device, all of the purge gas may be gas of the same component as the liquefied gas. For example, if the liquefied gas is liquid hydrogen, a part or all of the purge gas may be hydrogen gas. Examples of the gas treatment device include gas incinerator (flaring device), chemical gas treatment device, gas adsorption device, and the like.

In one embodiment, the purge-gas supply source 40 described above is a nitrogen-gas supply source or a helium-gas supply source. Further, in one embodiment, the purge-gas supply source 40 may include purge-gas supply sources of different types, such as a nitrogen-gas supply source and a helium-gas supply source. In this case, the purge-gas supply sources may be selectively coupled to the purge-gas supply line 38. Further, in one embodiment, the purge-gas supply source 40 may include a supply source of gas composed of the same component as that of the liquefied gas. For example, if the liquefied gas is liquid hydrogen, the purge-gas supply source 40 may include a hydrogen-gas supply source.

Helium gas is generally more expensive than nitrogen gas. Nitrogen has a larger atomic weight than that of helium, and therefore has a higher drying effect. Therefore, nitrogen gas may be used as the purge gas at first, and helium gas may be used as the purge gas in a final stage. For example, nitrogen gas is supplied into the integrally-transportable purge container 1 to replace the air in the interior space 20 of the container body 21 with nitrogen gas, and then helium gas is supplied into the integrally-transportable purge container 1 to fill the interior space 20 of the container body 21 with helium gas.

As shown in FIG. 2, the integrally-transportable purge container 1 further includes a pump suspension mechanism 45 detachably attached to the upper lid 23. The pump suspension mechanism 45 is configured to suspend the submersible pump 2 within the interior space 20 of the container body 21. The pump suspension mechanism 45 includes a coupling member 46 coupled to the submersible pump 2, and a stopper 47 engaged with the coupling member 46. More specifically, the coupling member 46 includes a coupling link 50 and a suspension cable 51 extending downward from the coupling link 50. The coupling link 50 has a projecting portion 50a projecting laterally. The stopper 47 is engaged with the projecting portion 50a of the coupling link 50.

The upper lid 23 has a hole 23a having a shape that does not allow passage of the stopper 47. A width of the hole 23a is larger than a width of the coupling link 50, so that the coupling link 50 is allowed to pass through the hole 23a. On the other hand, the width of the hole 23a is smaller than a width of the stopper 47, so that the stopper 47 is not allowed to pass through the hole 23a. The stopper 47 is placed on the upper surface of the upper lid 23 to prevent the coupling link 50 from falling into the container body 21.

As can be seen from FIG. 2, the load (or weight) of the submersible pump 2 is applied to the upper lid 23 via the pump suspension mechanism 45 including the coupling link 50 and the stopper 47. In other words, the load (or weight) of the submersible pump 2 is supported by the upper lid 23.

The stopper 47 is detachably engaged with the coupling link 50. In this embodiment, the stopper 47 is a split ring (e.g., two-split ring) constituting of a plurality of (typically two) members. However, the configurations of the coupling link 50 and the stopper 47 are not limited to this embodiment. For example, the stopper 47 may be a single member (e.g., a U-shaped member) having a gap extending outwardly from its center. Further, the coupling link 50 may be a shackle-like structure. In another example, the coupling link 50 may have a through-hole extending horizontally instead of having the projecting portion 50a, and the stopper 47 may be a rod member inserted into the through-hole. In this case also, the rod member does not pass through the hole 23a of the upper lid 23, and the coupling link 50 can be prevented from falling into the container body 21.

The upper lid 23 has a plurality of coupling ports 53 to which the cable 13 of the elevating device 12 is coupled. Each coupling port 53 is a structure having a hole through which the cable 13 can be inserted. A specific shape of each coupling port 53 is not particularly limited. The cable 13 is branched into a plurality of parts to have a plurality of distal ends. These distal ends are coupled to the coupling ports 53, respectively.

The lower lid 24 is removably placed on the bottom of the container body 21. The container body 21 has a lower flange 60 at a lower portion of the container body 21. The lower lid 24 is disposed on the lower flange 60. The lower lid 24 is a lid with no hole so that the purge gas filling the interior space 20 of the container body 21 does not leak through the lower lid 24. In one embodiment, the integrally-transportable purge container 1 includes a sealing member (not shown) that seals a gap between the container body 21 and the lower lid 24 when the lower lid 24 covers the lower opening of the container body 21. The sealing member is arranged to surround the lower opening of the container body 21 when the lower lid 24 covers the lower opening of the container body 21. In one embodiment, the lower lid 24 may be constructed from a plurality of members. For example, the lower lid 24 may be a two-split lid having two members. The lower flange 60 has a plurality of through-holes 60a into which a plurality of bolts (not shown) are inserted, respectively. The lower lid 24 may be removably secured to the container body 21 by screws or one or more clamps. The lower lid 24 may be a valve that can be opened and closed without removing it.

The integrally-transportable purge container 1 further includes a side lid 58 configured to close an opening 21b formed in the side wall 21a of the container body 21. The side lid 58 is removably fixed to the side wall 21a of the container body 21 by a fastening mechanism (for example, a plurality of screws) not shown. When the side lid 58 is removed, a worker can access the lower lid 24 in the container body 21 through the opening 21b and can remove the lower lid 24 from the container body 21. Similarly, a worker can bring the lower lid 24 into the container body 21 through the opening 21b and can place the lower lid 24 on the bottom of the container body 21 (i.e., on the lower flange 60).

The integrally-transportable purge container 1 includes a purge index measuring device 68 communicating with the purge-gas outlet port 28. The purge index measuring device 68 is configured to measure an index value indicating a degree of dryness of the submersible pump 2 that has been exposed to the purge gas, and/or to measure an index value indicating the temperature of the submersible pump 2 that has been exposed to the purge gas. Examples of the purge index measuring device 68 include dew-point meter, thermometer, and a combination thereof. For example, the dew-point meter measures an amount of moisture in the purge gas that has flowed out of the interior space 20 of the container body 21. Whether or not the submersible pump 2 exposed to the purge gas has been sufficiently dried (i.e., whether or not the drying-up operation described below is sufficiently performed) can be determined based on a measured value of the amount of moisture. The thermometer measures the temperature of the purge gas that has flowed out of the interior space 20. Whether or not the submersible pump 2 exposed to the purge gas has been sufficiently warmed (i.e., whether the hot-up operation described below is sufficiently performed) can be determined based on a measured value of the temperature of the purge gas that has contacted the submersible pump 2. The amount of moisture in the purge gas and the temperature of the purge gas are examples of index values for the drying-up operation and the hot-up operation for the submersible pump 2. The index values may be other physical quantities as long as they indicate the degree of dryness and the temperature of the submersible pump 2. In FIG. 2, the purge index measuring device 68 is coupled to the outlet valve 36, but the arrangement of the purge index measuring device 68 is not limited to the embodiment shown in FIG. 2, as long as the purge index measuring device 68 can fulfill its intended function.

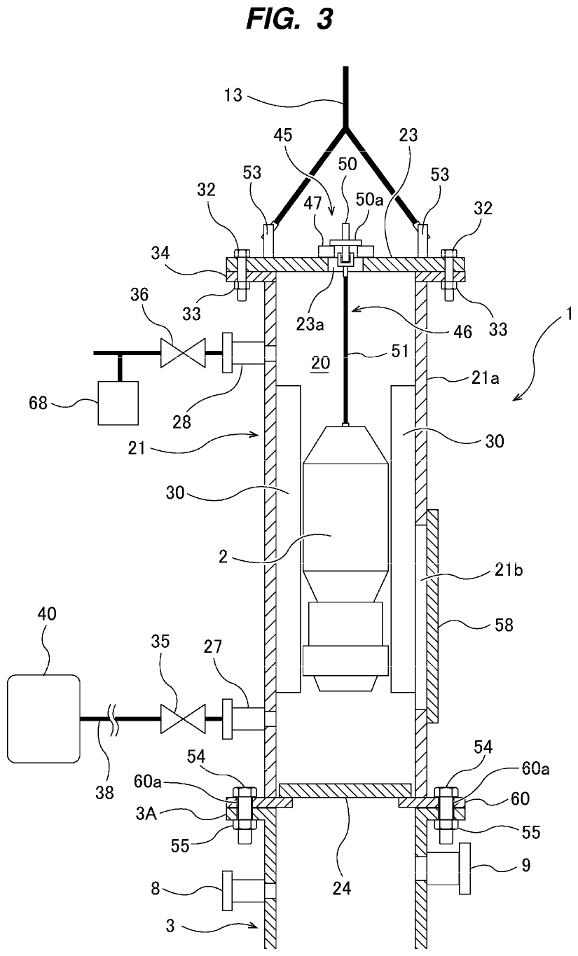

FIG. 3 is a schematic diagram showing the integrally-transportable purge container 1 coupled to the upper portion of the pump column 3. As shown in FIG. 3, the integrally-transportable purge container 1 with the submersible pump 2 housed therein is suspended from the cable 13 of the elevating device 12, and is lowered by the elevating device 12 until the lower flange 60 of the container body 21 is brought into contact with an upper flange 3A of the pump column 3. The lower flange 60 of the container body 21 is fixed to the upper flange 3A of the pump column 3 by bolts 54 and nuts 55 as a purge-container coupling mechanism. The bolts 54 extend in through-holes 60a formed in the lower flange 60 of the container body 21. In one embodiment, the purge-container coupling mechanism may be one or more clamps. The load of the submersible pump 2 is supported by the upper lid 23 and further supported by the pump column 3 via the container body 21.

In one embodiment, the submersible pump 2 may be placed on the lower lid 24. In this case, the pump suspension mechanism 45 including the coupling link 50 and the stopper 47 is not used, and the lower lid 24 is configured to support the submersible pump 2. More specifically, the lower lid 24 has sufficiently high mechanical strength to support the load of the submersible pump 2.

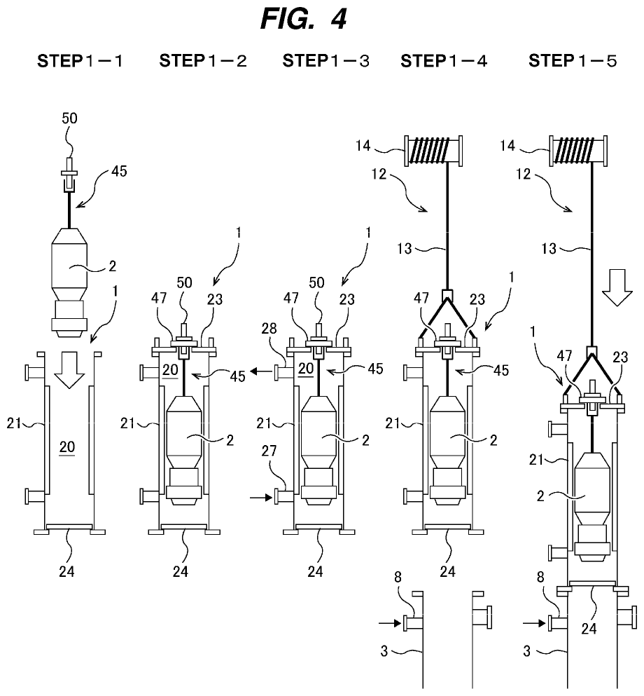

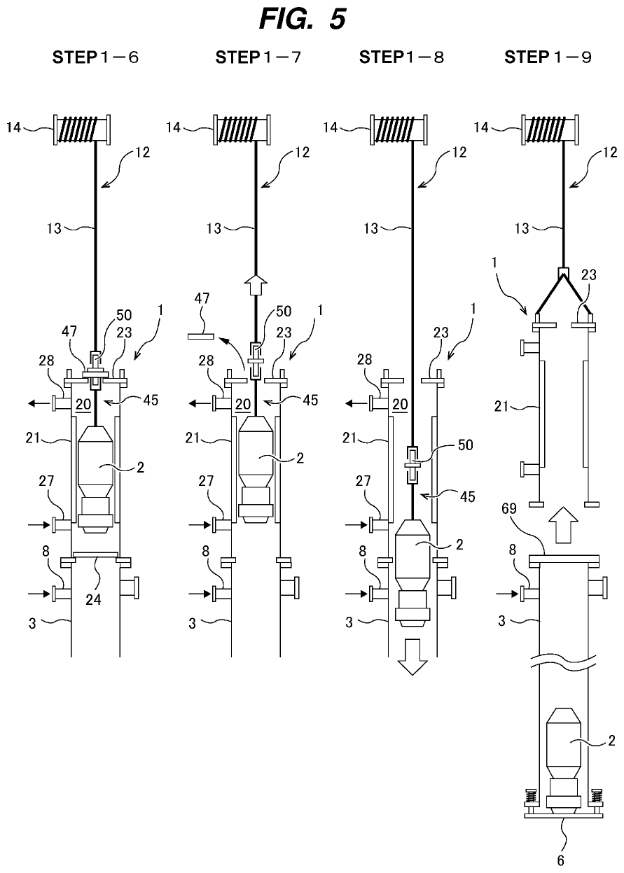

Next, an embodiment of a method of exposing the submersible pump 2 to the purge gas using the integrally-transportable purge container 1 described above will be described with reference to FIGS. 4 and 5. A series of operations shown in FIGS. 4 and 5 includes the drying-up operation of drying the submersible pump 2 with the purge gas and an operation of carrying the dried submersible pump 2 into the pump column 3. The liquefied gas is expelled from the pump column 3 prior to operations described below.

In step 1-1, the submersible pump 2 is placed in the interior space 20 of the container body 21 when the lower lid 24 is placed on the bottom of the container body 21 of the integrally-transportable purge container 1 and the upper lid 23 is removed from the container body 21. The submersible pump 2 is moved into the integrally-transportable purge container 1 by a transporting device (for example, a crane) not shown.

In step 1-2, when the submersible pump 2 is placed at a predetermined position in the container body 21, the upper lid 23 is attached to the upper portion of the container body 21. The load of the submersible pump 2 is supported by the upper lid 23 via the pump suspension mechanism 45 including the coupling link 50 and the stopper 47 (see FIG. 2). The upper lid 23 is firmly fixed to the container body 21 by the bolts 32 and the nuts 33 (see FIG. 2) which are the fixing device. Instead of the bolts 32 and the nuts 33, one or more clamps may be used to secure the upper lid 23 to the container body 21.

In step 1-3, while the upper opening of the container body 21 is covered with the upper lid 23 and the lower opening of the container body 21 is covered with the lower lid 24, the purge gas (including, for example, an inert gas and/or a gas having the same component as that of the liquefied gas) is supplied into the interior space 20 of the container body 21 through the purge-gas inlet port 27 to fill the interior space 20 in which the submersible pump 2 is disposed. The purge gas is discharged from the interior space 20 through the purge-gas outlet port 28. The purge gas expels air and moisture out of the submersible pump 2, so that the submersible pump 2 is dried up (the drying-up operation). An end of the drying-up operation is determined based on the index value (for example, a measured value of the amount of the moisture) output from the purge index measuring device 68.

In step 1-4, the integrally-transportable purge container 1 filled with the purge gas is transported together with the submersible pump 2 to a position above the pump column 3 by a transporting device (for example, a crane) which is not shown in the drawings. The cable 13 of the elevating device 12 is coupled to the upper lid 23. The integrally-transportable purge container 1 in which the submersible pump 2 is accommodated is suspended by the elevating device 12. In order to prevent the ambient air from entering the pump column 3, purge gas (e.g., including an inert gas and/or a gas having the same component as that of the liquefied gas) is introduced into the pump column 3 through the purge-gas introduction port 8. The supply of purge gas into the pump column 3 is continued in the following steps.

In step 1-5, the elevating device 12 lowers the integrally-transportable purge container 1 and the submersible pump 2, and the integrally-transportable purge container 1 is coupled to the upper portion of the pump column 3. Specifically, as described with reference to FIG. 3, the lower flange 60 of the container body 21 is fixed to the upper flange 3A of the pump column 3 by the bolts 54 and the nuts 55 (see FIG. 3) as a purge-container coupling mechanism. The load of the submersible pump 2 is supported by the pump column 3 via the upper lid 23.

In step 1-6, the purge gas (e.g., including an inert gas and/or a gas composed of the same component as that of the liquefied gas) is supplied through the purge-gas inlet port 27 into the interior space 20 of the container body 21, and the purge gas is exhausted from the interior space 20 through the purge-gas outlet port 28. At the same time, the purge gas flows out through minute gaps other than the purge-gas outlet port 28 of the integrally-transportable purge container 1. Such flow of the purge gas can prevent the ambient air from flowing into the container body 21.

Before or after the supply of the purge gas is started, the cable 13 is disconnected from the upper lid 23, and the cable 13 is coupled to the coupling link 50 of the pump suspension mechanism 45.

In step 1-7, the coupling link 50 and the submersible pump 2 are slightly elevated by the elevating device 12, and the stopper 47 is then removed. The load of the submersible pump 2 is supported by the elevating device 12. Furthermore, the lower lid 24 is removed from the container body 21.

In step 1-8, the elevating device 12 lowers the submersible pump 2 to move the submersible pump 2 from the integrally-transportable purge container 1 into the pump column 3.

In step 1-9, the submersible pump 2 is further lowered by the elevating device 12 until the submersible pump 2 is placed on the suction valve 6 installed at the bottom of the pump column 3. The cable 13 of the elevating device 12 is coupled to the upper lid 23. The bolts 54 and the nuts 55 (see FIG. 3), which are the purge-container coupling mechanism that couples the container body 21 of the integrally-transportable purge container 1 to the pump column 3, are removed. Then, the elevating device 12 pulls up the integrally-transportable purge container 1 to separate it from the pump column 3. Furthermore, the upper opening of the pump column 3 is closed with a lid 69.

In this way, the submersible pump 2 is dried up before being carried into the pump column 3.

According to this embodiment, air and moisture entrained with the submersible pump 2 are removed from the submersible pump 2 by the purge gas. As a result, the submersible pump 2 is dried up (deaerated). After the drying-up operation, the submersible pump 2 can be rapidly moved into the pump column 3 with the purge gas existing around the submersible pump 2. Therefore, the air and moisture are not entrained with the submersible pump 2 and do not enter the pump column 3.

The above step 1-3 is performed at a location away from the pump column 3. Therefore, the submersible pump 2 can be exposed to the purge gas even during the transportation of the integrally-transportable purge container 1 in the step 1-4 and during the coupling work of the integrally-transportable purge container 1 to the pump column 3 in the step 1-5, so that the drying-up operation for the submersible pump 2 progresses. Therefore, the entire working time can be shortened.

In one embodiment, the submersible pump 2 is installed in the integrally-transportable purge container 1, the integrally-transportable purge container 1 is then transported to the pump column 3 together with the submersible pump 2, subsequently the integrally-transportable purge container 1 is coupled to the pump column 3, and then the supply of the purge gas into the integrally-transportable purge container 1 is started. In other words, the drying-up operation for the submersible pump 2 may be started after the integrally-transportable purge container 1 is coupled to the pump column 3. Alternatively, in one embodiment, the submersible pump 2 is installed in the integrally-transportable purge container 1, the integrally-transportable purge container 1 is then transported to the pump column 3 together with the submersible pump 2, and then the supply of the purge gas into the integrally-transportable purge container 1 is started before the integrally-transportable purge container 1 is coupled to the pump column 3.

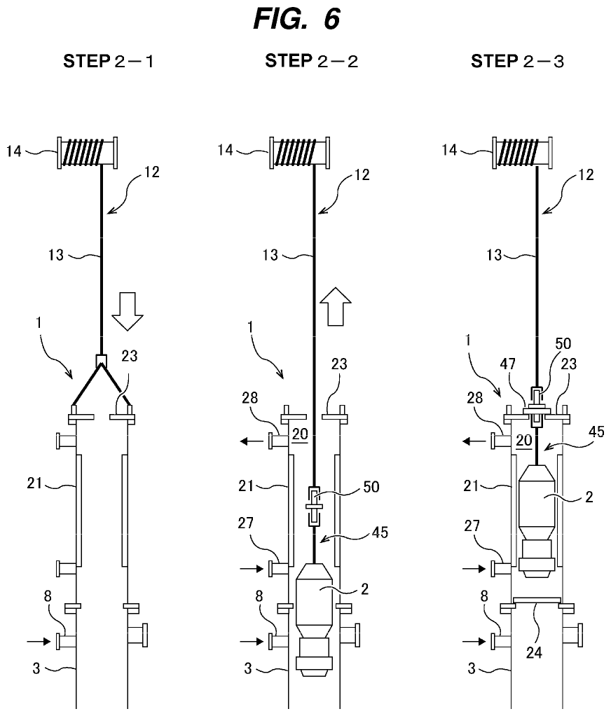

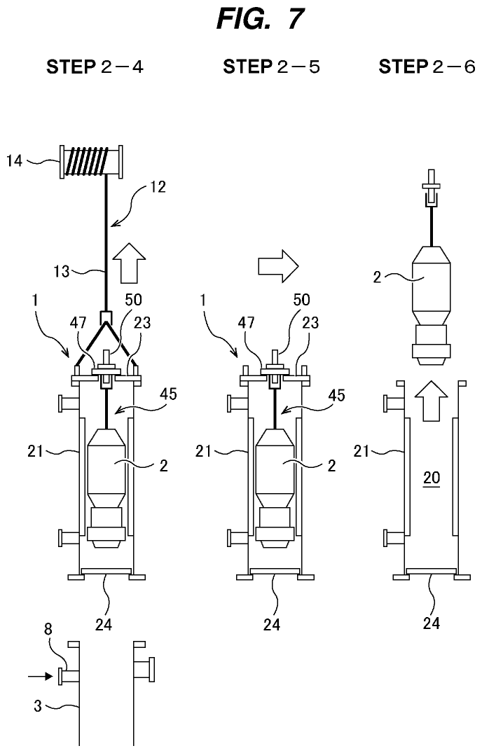

Next, an embodiment of processes of pulling up the submersible pump 2 from the pump column 3 will be described with reference to FIGS. 6 and 7. A series of operations shown in FIGS. 6 and 7 includes an operation of pulling up the submersible pump 2 out of the pump column 3, and the hot-up operation of warming the ultra-low temperature submersible pump 2 that has been in contact with the liquefied gas with the purge gas. The liquefied gas is expelled from the pump column 3 prior to operations described below.

In step 2-1, the integrally-transportable purge container 1 is lowered by the elevating device 12, and the integrally-transportable purge container 1 is coupled to the upper portion of the pump column 3. Specifically, as described with reference to FIG. 3, the lower flange 60 of the container body 21 is coupled to the upper flange 3A of the pump column 3 by the bolts 54 and the nuts 55 (see FIG. 3) as the purge-container coupling mechanism. At this stage, the lower lid 24 is not attached to the container body 21. The upper lid 23 is fixed to the upper portion of the container body 21 by the bolts 32 and the nuts 33 (see FIG. 2) as the fixing device, and the cable 13 of the elevating device 12 is coupled to the upper lid 23. Instead of the bolts 32 and the nuts 33, one or more clamps may be used to secure the upper lid 23 to the container body 21. In order to prevent the ambient air from entering the pump column 3, purge gas (e.g., including an inert gas and/or a gas having the same component as that of the liquefied gas) is introduced into the pump column 3 through the purge-gas introduction port 8. The supply of the purge gas into the pump column 3 is continued in the following steps.

In step 2-2, purge gas (e.g., inert gas and/or a gas composed of the same component as that of the liquefied gas) is supplied into the interior space 20 of the container body 21 through the purge-gas inlet port 27 to fill the interior space 20 with the purge gas, while the submersible pump 2 is pulled up from the pump column 3 into the integrally-transportable purge container 1 by the elevating device 12.

In step 2-3, when the submersible pump 2 is placed at a predetermined position in the container body 21, the lower lid 24 is placed on the bottom of the container body 21. Specifically, the side lid 58 shown in FIG. 2 is removed from the container body 21, the lower lid 24 is carried into the container body 21 through the opening 21b (see FIG. 2), and the lower lid 24 is placed onto the bottom of the container body 21 (i.e., onto the lower flange 60). The stopper 47 is placed onto the upper lid 23 and engaged with the coupling link 50. The load of the submersible pump 2 is supported by the upper lid 23 via the pump suspension mechanism 45 including the coupling link 50 and the stopper 47. With the upper opening of the container body 21 covered with the upper lid 23 and the lower opening of the container body 21 covered with the lower lid 24, the supply of the purge gas into the interior space 20 of the container body 21 through the purge-gas inlet port 27 is continued. The purge gas is discharged from the interior space 20 through the purge-gas outlet port 28. The purge gas to be supplied into the interior space 20 may have an ordinary temperature, or may be preheated by a heating device, such as a heater. The purge gas filling the interior space 20 of the container body 21 warms the submersible pump 2 (the hot-up operation). An end of the hot-up operation is determined based on the index value (for example, the measured value of the temperature of the purge gas) output from the purge index measuring device 68. The cable 13 of the elevating device 12 is disconnected from the pump suspension mechanism 45, and the cable 13 is coupled to the upper lid 23.

In step 2-4, the bolts 54 and the nuts 55 (see FIG. 3) as the purge-container coupling mechanism are removed, and the integrally-transportable purge container 1 with the submersible pump 2 disposed therein is elevated by the elevating device 12, so that integrally-transportable purge container 1 is separated from the pump column 3.

In step 2-5, the integrally-transportable purge container 1 accommodating the submersible pump 2 is moved to a location away from the pump column 3 by a transporting device (e.g., crane) which is not shown in the drawings.

In step 2-6, the upper lid 23 is removed from the container body 21, and the submersible pump 2 is removed from the integrally-transportable purge container 1 by a hoisting device (e.g., crane) not shown. At this point, the submersible pump 2 has already been warmed by the purge gas and has a temperature higher than the boiling point of oxygen (−183° C.). Therefore, even when the air comes into contact with the submersible pump 2, the oxygen and nitrogen in the air are not liquefied.

According to this embodiment, the ultra-low temperature submersible pump 2 can be warmed with the purge gas while being elevated from the pump column 3 into the integrally-transportable purge container 1 (the hot-up operation). This hot-up operation is performed before the submersible pump 2 contacts the atmospheric air, so that moisture in the air is not liquefied or solidified on the surfaces of the submersible pump 2. In particular, the present invention is effective when the liquefied gas is liquid hydrogen.

Specifically, the submersible pump 2 that has been immersed in liquid hydrogen has an ultra-low temperature equivalent to that of liquid hydrogen when the submersible pump 2 is pulled out of the pump column 3. The boiling point of hydrogen (−253° C.) is lower than the boiling point of oxygen (−183° C.) and the boiling point of nitrogen (−196° C.). Therefore, when the air comes into contact with the submersible pump 2 immediately after the submersible pump 2 is pulled up from the pump column 3, not only nitrogen in the air but also oxygen is liquefied and may drop into the pump column 3. In this regard, according to the present embodiment, the submersible pump 2 that has been immersed in liquid hydrogen is quickly warmed by the purge gas before the submersible pump 2 contacts the air. Therefore, when the air comes into contact with the submersible pump 2, the oxygen and nitrogen in the air are not liquefied, and the liquefied oxygen and liquefied nitrogen do not drop into the pump column 3. As a result, safe removal of the submersible pump 2 can be achieved.

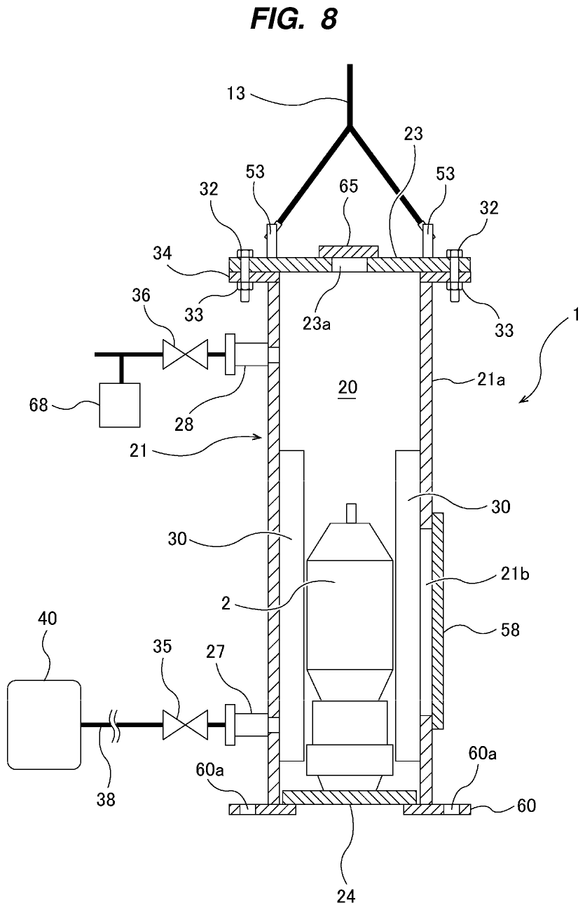

Next, another embodiment of the integrally-transportable purge container 1 will be described. FIG. 8 is a cross-sectional view showing another embodiment of the integrally-transportable purge container 1. Configurations of this embodiment, which will not be particularly described, are the same as those of the embodiment described with reference to FIGS. 2 and 3, and redundant descriptions thereof will be omitted. As shown in FIG. 8, the submersible pump 2 is supported by the lower lid 24 of the integrally-transportable purge container 1. Specifically, the submersible pump 2 is placed on the lower lid 24 without the pump suspension mechanism 45 shown in FIG. 2. Therefore, the load of the submersible pump 2 is supported by the lower lid 24. The lower lid 24 is configured to be able to support the submersible pump 2. More specifically, the lower lid 24 has sufficiently high mechanical strength to support the load of the submersible pump 2. The center of the upper lid 23 has the hole 23a through which the cable 13 of the elevating device 12 can pass. The hole 23a is closed by a second lid 65. The second lid 65 is removable from the upper lid 23.

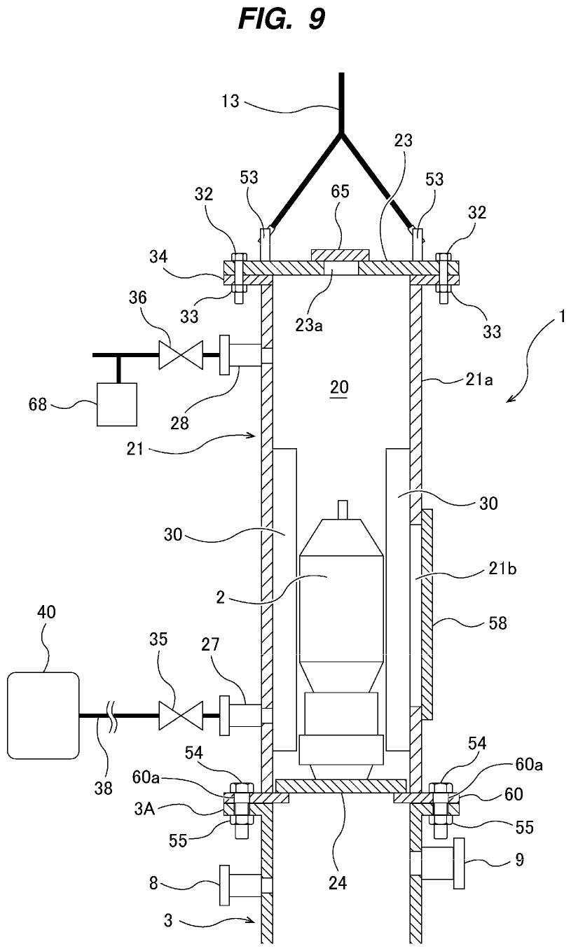

FIG. 9 is a schematic diagram showing the integrally-transportable purge container 1 coupled to the upper portion of the pump column 3. As shown in FIG. 9, the integrally-transportable purge container 1 with the submersible pump 2 disposed therein is suspended from the cable 13 of the elevating device 12 and is lowered by the elevating device 12 until the lower flange 60 of the container body 21 is brought into contact with the upper flange 3A of the pump column 3. The lower flange 60 of the container body 21 is fixed to the upper flange 3A of the pump column 3 by the bolts 54 and the nuts 55 as the purge-container coupling mechanism. The load of the submersible pump 2 is supported by the lower lid 24 and further supported by the pump column 3 via the lower lid 24

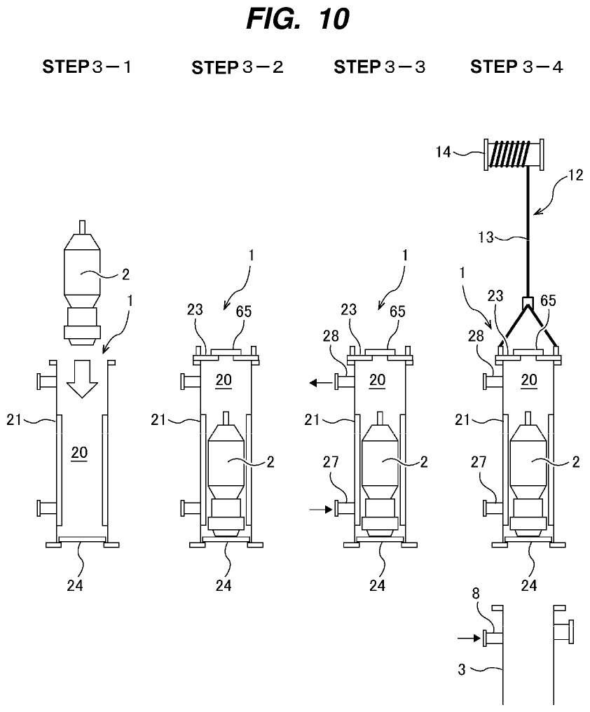

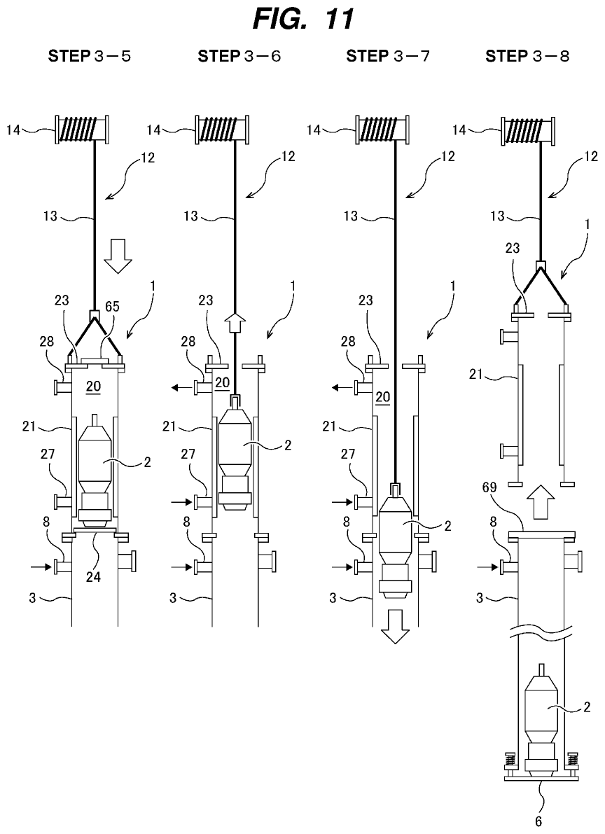

Next, an embodiment of a method for exposing the submersible pump 2 to the purge gas using the integrally-transportable purge container shown in FIG. 8 will be described with reference to FIGS. 10 and 11. A series of operations shown in FIGS. 10 and 11 includes the drying-up operation of drying the submersible pump 2 with the purge gas and an operation of putting the dried submersible pump 2 into the pump column 3. The liquefied gas is expelled from the pump column 3 prior to operations described below.

In step 3-1, the lower lid 24 is placed onto the bottom of the container body 21 of the integrally-transportable purge container 1, and the submersible pump 2 is placed in the interior space 20 of the container body 21 with the upper lid 23 removed. The submersible pump 2 is moved into the integrally-transportable purge container 1 by a transporting device (for example, a crane) not shown. The submersible pump 2 is placed on the lower lid 24, and the load of the submersible pump 2 is supported by the lower lid 24.

In step 3-2, the upper lid 23 is attached to the upper portion of the container body 21. The hole of the upper lid 23 is closed with the second lid 65. The upper lid 23 is firmly fixed to the container body 21 by the bolts 32 and the nuts 33 (see FIG. 8) which are the fixing device. Instead of the bolts 32 and the nuts 33, one or more clamps may be used to secure the upper lid 23 to the container body 21.

In step 3-3, while the upper opening of the container body 21 is covered with the upper lid 23 and the lower opening of the container body 21 is covered with the lower lid 24, the purge gas (including, for example, an inert gas and/or a gas having the same component as that of the liquefied gas) is supplied into the interior space 20 of the container body 21 through the purge-gas inlet port 27 to fill the interior space 20 in which the submersible pump 2 is disposed. The purge gas is discharged from the interior space 20 through the purge-gas outlet port 28. The purge gas expels air and moisture out of the submersible pump 2, so that the submersible pump 2 is dried up (the drying-up operation). An end of the drying-up operation is determined based on the index value (for example, a measured value of the amount of the moisture) output from the purge index measuring device 68.

In step 3-4, the integrally-transportable purge container 1 filled with the purge gas is transported together with the submersible pump 2 to a position above the pump column 3 by a transporting device (for example, a crane) which is not shown in the drawings. The cable 13 of the elevating device 12 is coupled to the upper lid 23. The integrally-transportable purge container 1 in which the submersible pump 2 is accommodated is suspended by the elevating device 12. In order to prevent the ambient air from entering the pump column 3, purge gas (e.g., including an inert gas and/or a gas having the same component as that of the liquefied gas) is introduced into the pump column 3 through the purge-gas introduction port 8. The supply of purge gas into the pump column 3 is continued in the following steps.

In step 3-5, the elevating device 12 lowers the integrally-transportable purge container 1 and the submersible pump 2, and the integrally-transportable purge container 1 is coupled to the upper portion of the pump column 3. Specifically, as described with reference to FIG. 9, the lower flange 60 of the container body 21 is fixed to the upper flange 3A of the pump column 3 by the bolts 54 and the nuts 55 (see FIG. 9) as the purge-container coupling mechanism. The load of the submersible pump 2 is supported by the pump column 3 via the lower lid 24.

In step 3-6, the purge gas (e.g., including an inert gas and/or a gas composed of the same component as that of the liquefied gas) is supplied through the purge-gas inlet port 27 into the interior space 20 of the container body 21, and the purge gas is exhausted from the interior space 20 through the purge-gas outlet port 28. The second lid 65 is removed. The cable 13 of the elevating device 12 extends through the hole of the upper lid 23 to the submersible pump 2 and is coupled to the submersible pump 2. Further, the submersible pump 2 is elevated up within the container body 21 by the elevating device 12, and then the lower lid 24 is removed from the container body 21. The load of the submersible pump 2 is supported by the elevating device 12. The purge gas flows out through the hole of the upper lid 23 as well as the purge-gas outlet port 28. Such flow of the purge gas can prevent the ambient air from flowing into the container body 21.

In step 3-7, the submersible pump 2 is lowered by the elevating device 12 so that the submersible pump 2 is moved from the integrally-transportable purge container 1 into the pump column 3. The supply of the purge gas into the container body 21 is continued.

In step 3-8, the submersible pump 2 is further lowered by the elevating device 12 until the submersible pump 2 is placed onto the suction valve 6 installed at the bottom of the pump column 3. The cable 13 of the elevating device 12 is coupled to the upper lid 23. The bolts 54 and the nuts 55 (see FIG. 9), which are the purge-container coupling mechanism that couples the container body 21 of the integrally-transportable purge container 1 to the pump column 3, are removed. Then, the elevating device 12 pulls up the integrally-transportable purge container 1 to separate it from the pump column 3. Furthermore, the upper opening of the pump column 3 is closed with the lid 69.

In one embodiment, the submersible pump 2 is installed in the integrally-transportable purge container 1, the integrally-transportable purge container 1 is then transported to the pump column 3 together with the submersible pump 2, subsequently the integrally-transportable purge container 1 is coupled to the pump column 3, and then the supply of the purge gas into the integrally-transportable purge container 1 is started. In other words, the drying-up operation for the submersible pump 2 may be started after the integrally-transportable purge container 1 is coupled to the pump column 3. Alternatively, in one embodiment, the submersible pump 2 is installed in the integrally-transportable purge container 1, the integrally-transportable purge container 1 is then transported to the pump column 3 together with the submersible pump 2, and then the supply of the purge gas into the integrally-transportable purge container 1 is started before the integrally-transportable purge container 1 is coupled to the pump column 3.

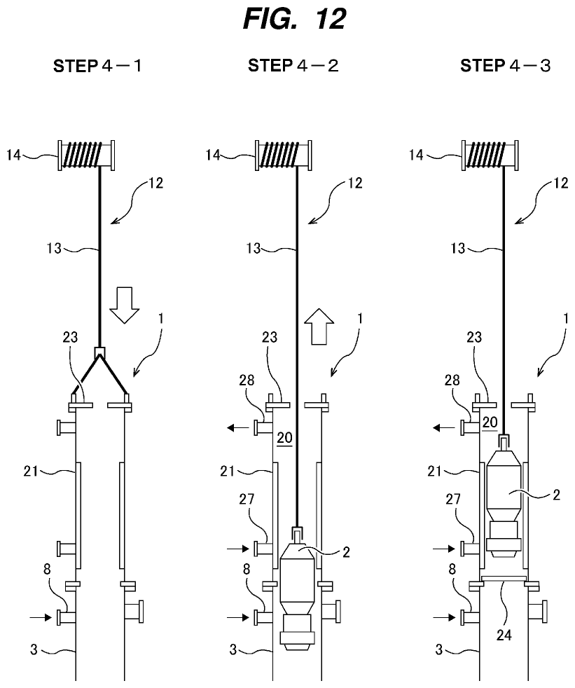

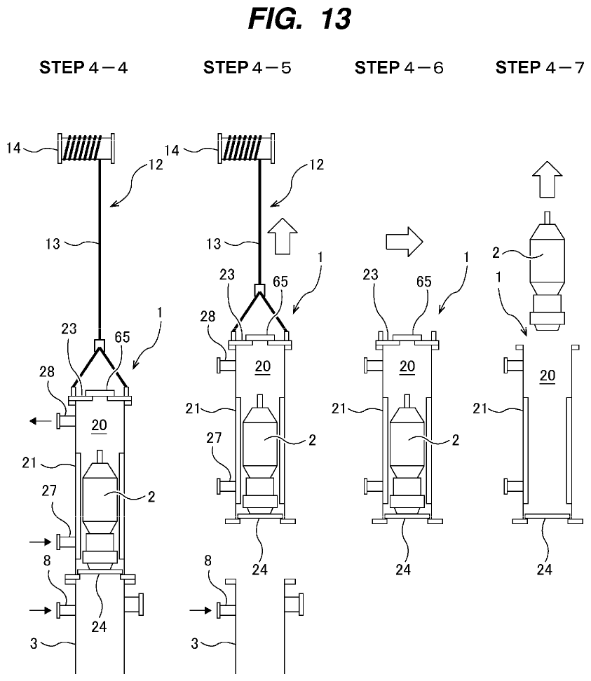

Next, an embodiment of processes of pulling up the submersible pump 2 from the pump column 3 will be described with reference to FIGS. 12 and 13. A series of operations shown in FIGS. 12 and 13 includes an operation of pulling up the submersible pump 2 out of the pump column 3, and the hot-up operation of warming the ultra-low temperature submersible pump 2 that has been in contact with the liquefied gas with the purge gas. The liquefied gas is expelled from the pump column 3 prior to operations described below.

In step 4-1, the integrally-transportable purge container 1 is lowered by the elevating device 12, and the integrally-transportable purge container 1 is coupled to the upper portion of the pump column 3. Specifically, as described with reference to FIG. 9, the lower flange 60 of the container body 21 is coupled to the upper flange 3A of the pump column 3 by the bolts 54 and the nuts 55 (see FIG. 9) as the purge-container coupling mechanism. At this stage, the lower lid 24 is not attached to the container body 21. The upper lid 23 is fixed to the upper portion of the container body 21 by the bolts 32 and the nuts 33 (see FIG. 8) as the fixing device, and the cable 13 of the elevating device 12 is coupled to the upper lid 23. Instead of the bolts 32 and the nuts 33, one or more clamps may be used to secure the upper lid 23 to the container body 21. In FIG. 12, the second lid 65 (see FIG. 8) has been removed from the upper lid 23, while the second lid 65 may be attached to the upper lid 23. In order to prevent the ambient air from entering the pump column 3, purge gas (e.g., including an inert gas and/or a gas having the same component as that of the liquefied gas) is introduced into the pump column 3 through the purge-gas introduction port 8. The supply of the purge gas into the pump column 3 is continued in the following steps.

In step 4-2, purge gas (e.g., inert gas and/or a gas composed of the same component as that of the liquefied gas) is supplied into the interior space 20 of the container body 21 through the purge-gas inlet port 27 to fill the interior space 20 with the purge gas, while the submersible pump 2 is pulled up from the pump column 3 into the integrally-transportable purge container 1 by the elevating device 12. The second lid 65 (see FIG. 8) has been removed from the upper lid 23.

In step 4-3, when the submersible pump 2 is located in the container body 21, the lower lid 24 is placed on the bottom of the container body 21. Specifically, the side lid 58 shown in FIG. 8 is removed from the container body 21, the lower lid 24 is carried into the container body 21 through the opening 21b (see FIG. 8), and the lower lid 24 is placed onto the bottom of the container body 21 (i.e., onto the lower flange 60).

In step 4-4, the submersible pump 2 is lowered in the container body 21 by the elevating device 12, until the submersible pump 2 is placed on the lower lid 24. The load of the submersible pump 2 is supported by the lower lid 24. Furthermore, the second lid 65 is attached to the upper lid 23. With the upper opening of the container body 21 covered with the upper lid 23 and the lower opening of the container body 21 covered with the lower lid 24, the supply of the purge gas into the interior space 20 of the container body 21 through the purge-gas inlet port 27 is continued. The purge gas is discharged from the interior space 20 through the purge-gas outlet port 28. The purge gas to be supplied into the interior space 20 may have an ordinary temperature, or may be preheated by a heating device, such as a heater. The purge gas filling the interior space 20 of the container body 21 warms the submersible pump 2 (the hot-up operation). An end of the hot-up operation is determined based on the index value (for example, the measured value of the temperature of the purge gas) output from the purge index measuring device 68. The cable 13 of the elevating device 12 is disconnected from the submersible pump 2, and the cable 13 is coupled to the upper lid 23.

In step 4-5, the bolts 54 and the nuts 55 (see FIG. 9) as the purge-container coupling mechanism are removed, and the integrally-transportable purge container 1 with the submersible pump 2 disposed therein is elevated by the elevating device 12, so that integrally-transportable purge container 1 is separated from the pump column 3.

In step 4-6, the integrally-transportable purge container 1 in which the submersible pump 2 is accommodated is moved to a location away from the pump column 3 by a transport device (e.g., a crane) not shown.

In step 4-7, the upper lid 23 is removed from the container body 21, and the submersible pump 2 is removed from the integrally-transportable purge container 1 by a hoisting device (e.g., crane) not shown. At this point, the submersible pump 2 has already been warmed by the purge gas and has a temperature higher than the boiling point of oxygen (−183° C.) and the boiling point of nitrogen (−196° C.). Therefore, even when the air comes into contact with the submersible pump 2, the oxygen and nitrogen in the air are not liquefied.

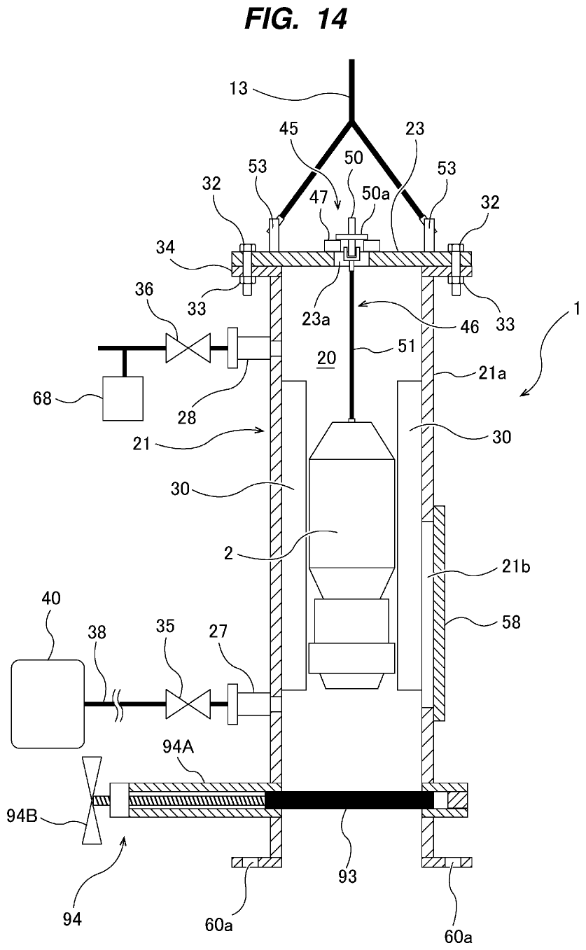

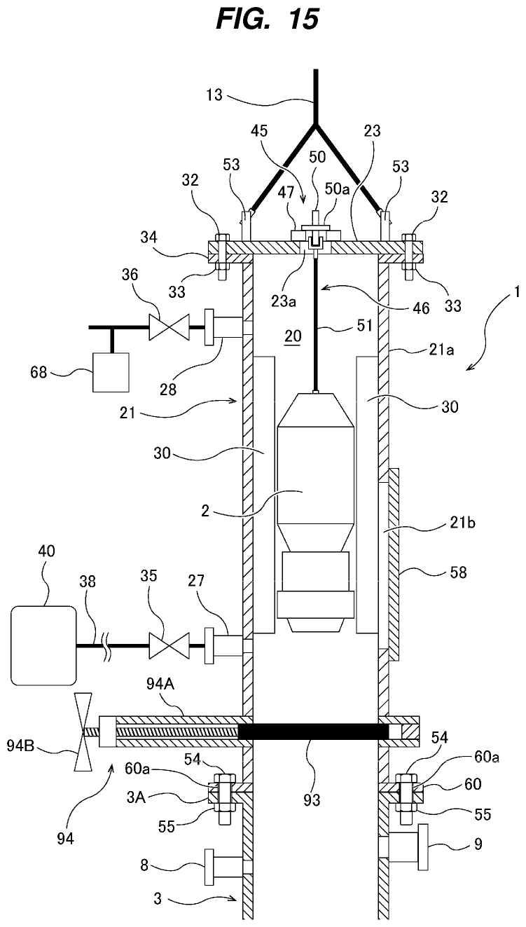

Next, still another embodiment of the integrally-transportable purge container 1 will be described. FIG. 14 is a cross-sectional view showing still another embodiment of the integrally-transportable purge container 1, and FIG. 15 is a schematic diagram showing the integrally-transportable purge container 1 coupled to the upper portion of the pump column 3. Configurations of this embodiment, which will not be particularly described, are the same as those of the embodiment described with reference to FIGS. 2 and 3, and redundant descriptions thereof will be omitted.

As shown in FIG. 14, the integrally-transportable purge container 1 has a gate valve 93 arranged at its lower portion and a gate-valve opening-closing device 94 coupled to the gate valve 93. The gate valve 93 functions as a lower lid that covers the lower opening of the container body 21. The lower lid 24 and the side lid 58 described with reference to FIG. 2 are not provided. Further, the side wall 21a of the container body 21 of the integrally-transportable purge container 1 does not have the opening 21b described with reference to FIG. 2. The gate valve 93 is movable in a direction perpendicular to a longitudinal direction of the integrally-transportable purge container 1 and the pump column 3.

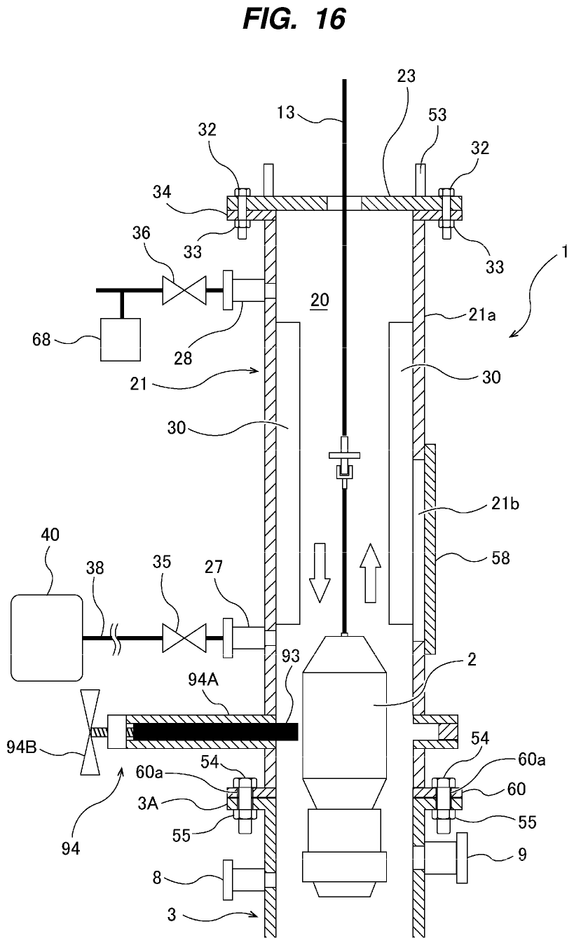

As shown in FIG. 15, when the integrally-transportable purge container 1 is coupled to the upper portion of the pump column 3, the gate valve 93 is located between the container body 21 of the integrally-transportable purge container 1 and the upper end of the pump column 3. When the gate valve 93 closes the lower opening of the container body 21, the fluid communication between the interior space 20 of the integrally-transportable purge container 1 and the interior space of the pump column 3 is cut off. As shown in FIG. 16, when the gate valve 93 is opened, the submersible pump 2 can be moved between the interior space 20 of the integrally-transportable purge container 1 and the interior space of the pump column 3.

The gate-valve opening-closing device 94 is arranged outside the interior space 20 of the integrally-transportable purge container 1. The gate-valve opening-closing device 94 includes a screw driving mechanism 94A having a screw shaft, and an opening-closing handle 94B for rotating the screw shaft. The gate valve 93 is coupled to the screw driving mechanism 94A, and the opening-closing handle 94B is also coupled to the screw driving mechanism 94A. When a worker rotates the opening-closing handle 94B in one direction, the gate valve 93 can be opened, and when the worker rotates the opening-closing handle 94B in the opposite direction, the gate valve 93 can be closed.

The opening-closing handle 94B is arranged outside the container body 21 of the integrally-transportable purge container 1. Therefore, the worker can open and close the gate valve 93 from outside the container body 21 (i.e., from outside the integrally-transportable purge container 1). The gate-valve opening-closing device 94 of the present embodiment is a manual gate-valve opening-closing device, while in one embodiment, the gate-valve opening-closing device 94 may be an actuator-driven gate-valve opening-closing device, such as an electric gate-valve opening-closing device.

The method of exposing the submersible pump 2 to the purge gas using the integrally-transportable purge container 1 according to the embodiments described with reference to FIGS. 14 to 16 is the same as the embodiments described with reference to FIGS. 4 and 5 except for opening the gate valve 93 instead of removing the lower lid 24, and therefore repetitive descriptions thereof are omitted.

The method of elevating the submersible pump 2 from the pump column 3 and exposing the submersible pump 2 to the purge gas using the integrally-transportable purge container 1 according to the embodiments described with reference to FIGS. 14 to 16 is the same as the embodiment described with reference to FIGS. 6 and 7 except for closing the gate valve 93 instead of disposing the lower lid 24, and therefore repetitive descriptions thereof are omitted.

The gate-valve opening-closing device 94 can open and close the gate valve 93 while the interior space 20 of the integrally-transportable purge container 1 is kept in a sealed condition, thus preventing the ambient air from entering the integrally-transportable purge container 1. As a result, the ambient air can be prevented from entering the integrally-transportable purge container 1, and the submersible pump 2 can be safely carried in and out of the liquefied-gas storage tank 5 via the integrally-transportable purge container 1 provided on the upper portion of the pump column 3.

The previous description of embodiments is provided to enable a person skilled in the art to make and use the present invention. Moreover, various modifications to these embodiments will be readily apparent to those skilled in the art, and the generic principles and specific examples defined herein may be applied to other embodiments. Therefore, the present invention is not intended to be limited to the embodiments described herein but is to be accorded the widest scope as defined by limitation of the claims.

### INDUSTRIAL APPLICABILITY

The present invention is applicable to an integrally-transportable purge container for exposing a submersible pump for pressurizing a liquefied gas, such as liquefied ammonia, liquefied natural gas (LNG), or liquid hydrogen, to purge gas. Further, the present invention is applicable to a method of exposing the submersible pump to the purge gas using such an integrally-transportable purge container.

### REFERENCE SIGNS LIST

1 integrally-transportable purge container
2 submersible pump
3 pump column
5 liquefied-gas storage tank
6 suction valve
8 purge-gas introduction port
9 purge-gas discharge port
12 elevating device
13 cable
14 hoisting device
20 interior space
21 container body
23 upper lid
23a hole
24 lower lid
27 purge-gas inlet port
28 purge-gas outlet port
30 pump guide
32 bolt
33 nut
34 upper flange
35 inlet valve
36 outlet valve
38 purge-gas supply line
40 purge-gas supply source
45 pump suspension mechanism
46 coupling member
47 stopper
50 coupling link
51 suspension cable
53 coupling port
54 bolt
55 nut
58 side lid
60 lower flange
68 purge index measuring device
93 gate valve
94 gate-valve opening-closing device
94A screw driving mechanism
94B opening-closing handle

What is claimed is:

1. An integrally-transportable purge container for exposing a submersible pump to purge gas, the submersible pump being used to deliver liquefied gas, the integrally-transportable purge container comprising:
a container body having an interior space for accommodating the submergible pump therein;
an upper lid configured to cover an upper opening of the container body;
a lower lid configured to cover a lower opening of the container body; and
a purge-gas inlet port and a purge-gas outlet port communicating with the interior space of the container body; and
a pump guide fixed to an inner surface of the container body, the pump guide being configured to suppress lateral shaking of the submergible pump,
the integrally-transportable purge container being configured to be detachably coupled to an upper portion of a pump column in which the submergible pump is to be installed, and
the integrally-transportable purge container being configured to be transportable together with the submergible pump.

2. (canceled)

3. The integrally-transportable purge container according to claim 1, further comprising a fixing device configured to removably fix the upper lid to the container body.

4. The integrally-transportable purge container according to claim 1, further comprising a side lid configured to close an opening formed in a side wall of the container body.

5. The integrally-transportable purge container according to claim 1, further comprising:
an inlet valve coupled to the purge-gas inlet port; and
an outlet valve coupled to the purge-gas outlet port.

6. The integrally-transportable purge container according to claim 1, further comprising a pump suspension mechanism removably attached to the upper lid, the pump suspension mechanism being configured to suspend the submergible pump within the interior space.

7. The integrally-transportable purge container according to claim 6, wherein
the pump suspension mechanism includes a coupling member coupled to the submersible pump, and a stopper engaged with the coupling member, and
the upper lid has a hole having a shape that does not allow the stopper to pass through the hole.

8. The integrally-transportable purge container according to claim 1, wherein the lower lid is configured to support the submergible pump.

9. The integrally-transportable purge container according to claim 1, wherein the lower lid is removably attached to the container body.

10. The integrally-transportable purge container according to claim 1, wherein the lower lid is composed of a gate valve, and the purge container further comprises a gate-valve opening-closing device configured to open and close the gate valve.

11. An integrally-transportable purge container for exposing a submersible pump to purge gas, the submersible pump being used to deliver liquefied gas, the integrally-transportable purge container comprising:
a container body having an interior space for accommodating the submergible pump therein;
an upper lid configured to cover an upper opening of the container body;
a lower lid configured to cover a lower opening of the container body;
a purge-gas inlet port and a purge-gas outlet port communicating with the interior space of the container body; and
a sealing member configured to seal a gap between the container body and the lower lid when the lower lid covers the lower opening of the container body,
wherein the lower opening of the container body has a size that allows the submergible pump to pass through the lower opening when the lower lid is removed, and
the integrally-transportable purge container is transportable together with the submergible pump disposed in the container body to an upper portion of a pump column and away from the upper portion of the pump column.

12. An integrally-transportable purge container for exposing a submersible pump to purge gas, the submersible pump being used to deliver liquefied gas, the integrally-transportable purge container comprising:
a container body having an interior space for accommodating the submergible pump therein;
an upper lid configured to cover an upper opening of the container body;
a lower lid configured to cover a lower opening of the container body;
a purge-gas inlet port and a purge-gas outlet port communicating with the interior space of the container body; and
a pump guide configured to suppress lateral shaking of the submergible pump when the submergible pump is in the container body,
wherein a predetermined clearance is maintained between the pump guide and the submergible pump, and
the integrally-transportable purge container is transportable together with the submergible pump disposed in the container body to an upper portion of a pump column and away from the upper portion of the pump column.

13. (canceled)

14. (canceled)

15. (canceled)

16. (canceled)

17. (canceled)

18. (canceled)

19. (canceled)

20. (canceled)

21. (canceled)
